(19) United States
(12) Patent Application Publication
(10) Pub. No.: US 2001/0041549 A1
(43) Pub. Date: Nov. 15, 2001

(54) CARD-TYPE RADIO DEVICE.

(76) Inventor: MASANOBU OKADA, SAGAMIHARA-SHI (JP)

Correspondence Address: OSTROLENK FABER GERB & SOFFEN, 1180 AVENUE OF THE AMERICAS, NEW YORK, NY, 100368403

(21) Appl. No.: 09/233,651

(22) Filed: Jan. 16, 1999

(30) Foreign Application Priority Data
Jan. 16, 1998 (JP) 10-6794

(51) Int. Cl. H04B 1/26

(52) U.S. Cl. 455/327; 455/313; 455/325

(57) ABSTRACT

A card-type radio device being capable of setting an antenna at a position where good transmission/reception sensitivity can be obtained is provided. The card-type radio device is constituted by a first housing having a radio communication circuit built therein and a second housing having an antenna built therein. The first housing and the second housing are freely detached/attached to/from each other by using an engagement means. When the card-type radio device is set in an information terminal device, the second housing is separated from the first housing, and the second housing is located at a position where the antenna has good transmission/reception sensitivity.

### BACKGROUND OF THE INVENTION

1. Field of the Invention

The present invention relates to a card-type radio device for transmitting/receiving data by using radio communication.

2. Description of the Related Art

For example, in an information terminal device such as notebook-sized personal computer or an electronic organizer, a card slot conforming to the PCMCIA (Personal Computer Memory Card International Association) standard and the JEIDA (Japan Electronic Industry Development Association) standard is arranged. PC cards for various purposes which can be loaded into the card slot are developed.

In recent years, a system for transmitting/receiving data by using radio waves in a LAN (Local Area Network) structured between information terminal devices or between an information terminal device and a workstation is developed, and a PC card serving as a card-type radio device in which a radio communication circuit is built is developed.

As an example, a system for transmitting/receiving data by using radio communication between information terminal devices will be described below by using FIG. 6.

An information terminal device 1 in this system is connected to a nearest base station 3A by using a wireless transmission line 2 like a path A shown in FIG. 6. The base station 3A is connected to another information terminal device 5 through the wireless transmission line 2 or a wire transmission line 4. As a result, the information terminal devices 1 and 5 are connected to each other to transmit/receive data. The information terminal devices 1 and 5 may be connected to each other through a plurality of base stations 3B and 3C connected to each other by a wire transmission line 6 like a path B shown in FIG. 6.

A card-type radio device described in Japanese Unexamined Patent Publication No. 8-279027 will be described below by using FIG. 7 and FIG. 8.

A card-type radio device 7 is used while being inserted into a card slot 8 formed in a side surface of the housing of the information terminal device 1. The housing of the card-type radio device 7 conforms to the PCMCIA standard and the JEIDA standard and is formed into the shape of a rectangular plate having a thickness of 5 mm, one side with 54 mm, and the other side with a predetermined length.

A 68-pin connector 9 provided on a first side surface 7A of the card-type radio device 7 is inserted into the card slot 8 of the information terminal device 1. The 68-pin connector 9 is electrically connected to the radio communication circuit disposed in the card-type radio device 7.

On a second side surface 7B opposing the first side surface 7A of the card-type radio device 7, a terminal (not shown) electrically connected to the radio communication circuit of the card-type radio device 7 is provided. This terminal is connected to an external module 13 having an antenna 12 through a cable 11 having an exclusive connector 10.

Connection terminals (not shown) are arrayed in the card slot 8. When the card-type radio device 7 is inserted into the card slot 8, the connector 9 is electrically connected to the connection terminals. After the information terminal device 1 is connected to the card-type radio device 7 and the external module 13, the information terminal device 1 can transmit and receive data using radio waves.

The card-type radio device is not limited to the above structure. Another card-type radio device 14 will be briefly described below by using FIG. 9.

The card-type radio device 14 is integrally constituted by a housing 15 in which a communication circuit is built and an extending portion 16. An antenna 12 is arranged on the extending portion 16 to be electrically connected to the communication circuit of the housing 15.

A connector 9 provided on a first side surface 14A of the card-type radio device 14 on the side is inserted into the card slot 8. The connector 9 is electrically connected to the communication circuit of the card-type radio device 14.

When the card-type radio device 14 is inserted into the card slot 8, connection terminals arrayed in the card slot 8 are electrically connected to the connector 9. The information terminal device 1 is electrically connected to the card-type radio device 14 and the device 1 can transmit and receive data using radio waves.

The circuit arrangement of the radio communication circuit 17 used for the card-type radio devices 7 and 14 will be briefly described below by using FIG. 10.

The radio communication circuit 17 is roughly divided into a high-frequency RF (Radio Frequency) module 18 and a data processor 19.

The high-frequency RF module 18 is constituted by a duplexer 20, a receiver 21, a transmitter 22, and a synthesizer 23. In the high-frequency RF module 18, the antenna 12 is connected either the receiver 21 or the transmitter 22 by the duplexer 20 to switch transmission and reception to each other.

In the receiver 21, an input signal RX received through the antenna 12 and the duplexer 20 is mixed with a local signal given by the synthesizer 23 to form an IF (Intermediate Frequency) signal of an intermediate frequency band. The IF signal is output to the data processor 19 comprising of a baseband circuit, a control circuit, and the like. The signal processed by the data processor 19 is output to the information terminal device 1 connected to the data processor 19 as information.

The information output from the information terminal device 1 is processed by the data processor 19 to be output to the transmitter 22. In the transmitter 22, the signal processed by the data processor 19 is modulated and mixed with a local signal given by the synthesizer 23 to form a transmission signal TX. The transmission signal TX is transmitted through the duplexer 20 and the antenna 12.

However, when data transmission/reception is performed by using the card-type radio device 7 and the external module 13, the exclusive connector 10 erroneously detaches from the terminal of the card-type radio device 7 and the data transmission/reception may stop during operation. When a user carries the information terminal device 1, if the information terminal device 1 requires a plurality of parts to be used, the user easily forgets these parts. If the user forgets to carry the parts, data transmission/reception cannot be performed.

In data transmission/reception performed by using the card-type radio device 14 with the housing 15 and the extending portion 16 integrally constituted, when the card-type radio device 14 is inserted into the card slot 8, if the information terminal device 1 is a relatively large device like a notebook-sized personal computer, the extending portion 16 may be in the shadow of the information terminal device 1. At this time, if the information terminal device 1 cannot be freely moved by the keyboard or the display arranged in the information terminal device 1, the transmission/reception sensitivity of the antenna 12 built in the extending portion 16 may deteriorate. In this state, when communication is performed, the following various problems may occur. Communication is disconnected by noise generated in data transmission/reception or a data error occurs if character data is transmitted/received. In short the antenna 12 of the card-type radio device 14 can not be put at a place where the sensitivity of the antenna is desirable since the antenna 12 is integrally formed in the radio device 14.

### SUMMARY OF THE INVENTION

It is, therefore, an object of the present invention to provide a card-type radio device for solving the above problem.

A card-type radio device according to the present invention comprises of a radio communication circuit and an antenna used for transmitting/receiving data. The radio communication circuit is built in a first housing. The antenna is built in a second housing. The radio communication circuit and the antenna are electrically connected to each other through a cable, and the first housing and the second housing are detachably engaged with each other by engagement means.

The first housing in which the radio communication circuit is built and the second housing in which the antenna is built are freely detached/attached to/from each other through the engagement means. For this reason, when data is transmitted/received by using a card-type radio device, the second housing can be used while being separated from the first housing. Therefore, when the position of the second housing is changed, the antenna can be set at a position where the antenna can have good reception sensitivity.

### BRIEF DESCRIPTION OF THE DRAWINGS

FIG. 1 is a perspective view of a card-type radio device according to the present invention.

FIG. 2 is a perspective view showing a case wherein a first housing and a second housing constituting the card-type radio device according to the present invention are separated from each other.

FIG. 3 is a view showing an example of a method of storing a cable in the card-type radio device, in which FIG. 3A is a view showing a take-up means and FIG. 3B is a view showing a holding means.

FIG. 4 is a view showing another engagement means for engaging the first housing and the second housing constituting a card-type radio device according to the present invention.

FIG. 5 is a view showing still another engagement means for engaging the first housing and the second housing constituting a card-type radio device according to the present invention.

FIG. 6 is a typical view showing data transmission/reception between information terminal devices by using a radio device.

FIG. 7 is a typical view showing a case wherein a card-type radio device is inserted into a card slot formed in the information terminal device to be used.

FIG. 8 is a perspective view of a conventional card-type radio device.

FIG. 9 is a perspective view of another conventional card-type radio device.

FIG. 10 is a block diagram of a communication circuit used in a card-type radio device.

### DESCRIPTION OF THE PREFERRED EMBODIMENT

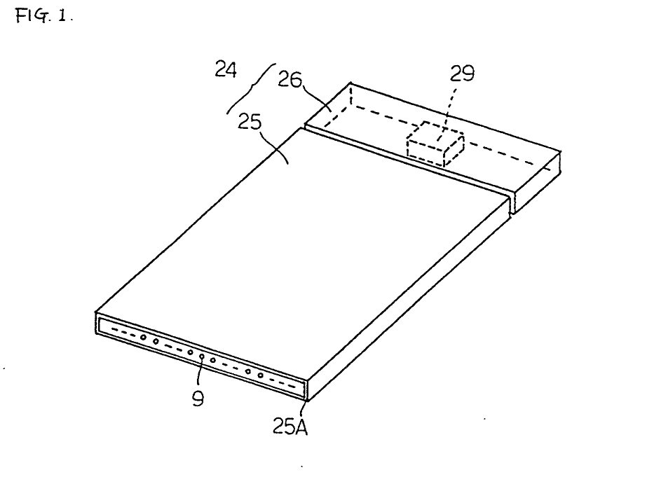

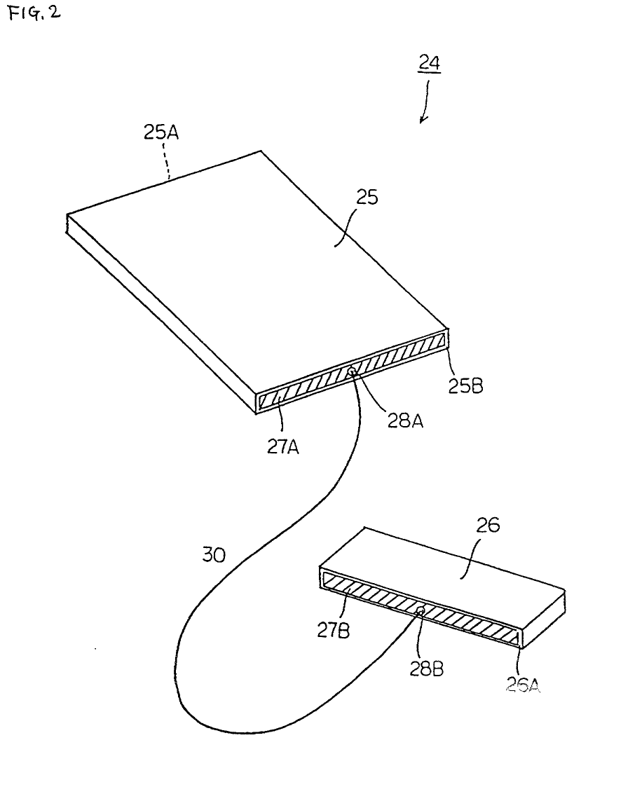

A card-type radio device 24 according to the present invention will be described below by using FIG. 1 and FIG. 2. The same reference numerals as in the prior art denote the same parts in this embodiment. The card-type radio device 24 will be described while illustrating a card-type radio device conforming to the PCMCIA standard and the JEIDA standard as an example.

The card-type radio device 24 is constituted by a first housing 25 and a second housing 26.

A radio communication circuit 17 mounted on a circuit board is built in the first housing 25. The 68-pin connector 9 is provided on a first side surface 25A of the first housing 25. The connector 9 is inserted into the card slot 8. In a second side surface 25B opposing the first side surface 25A of the first housing 25, a fastener 27A having a hook member formed on the surface thereof is stuck by using an organic adhesive agent or the like. An insertion hole 28A is formed in the second side surface 25B and the fastener 27A.

An antenna 29 consisting of, e.g., dielectric ceramic is built in the second housing 26. On a fitting surface 26A of the second housing 26 overlapping the second side surface 25B, a fastener 27B having a hook member formed on the surface thereof is stuck by using an organic adhesive agent. An insertion hole 28B is formed in the fitting surface 26A and the fastener 27B.

The radio communication circuit 17 arranged in the first housing 25 and the antenna 29 arranged in the second housing 26 are electrically connected to each other through a cable 30 inserted into the insertion holes 28A and 28B. As the cable 30, a flexible coaxial cable is generally used to avoid an influence of external noise. Depending on the wavelength of a frequency to be used, the length of the cable 30 is determined.

The first housing 25 and the second housing 26 are integrally engaged with each other by the fasteners 27A and 27B. More specifically, when the fasteners 27A and 27B are overlapped and pressed to each other, hook members formed on the surfaces of the fasteners 27A and 27B are engaged with each other. When the fasteners 27A and 27B are removed from each other, the hook members are disengaged from each other, and the first housing 25 is separated from the second housing 26.

Since the cable 30 is stored in the card-type radio device 24, a take-up means for the cable 30 is arranged in the first housing 25.

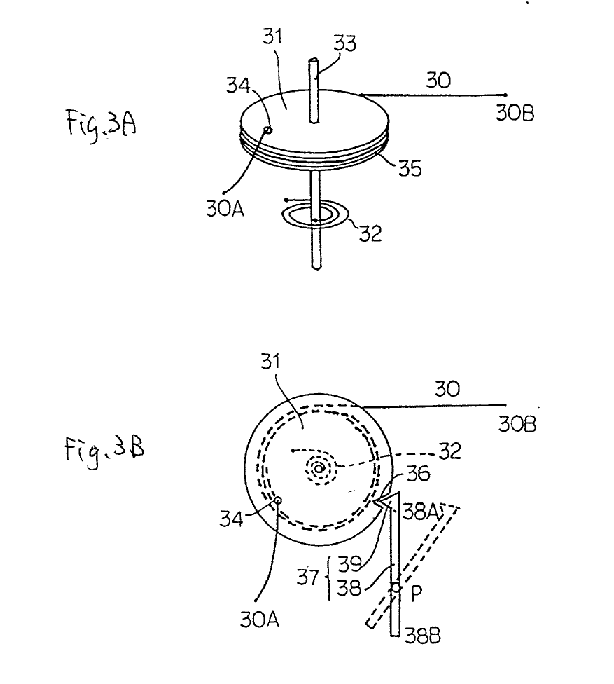

A take-up means will be briefly described below by using FIG. 3A.

The take-up means is constituted by a take-up pulley 31 and a take-up spring 32. Both the ends of a core shaft 33 of the take-up pulley 31 are pivoted by bearings (not shown) oppositely arranged on the front and rear surfaces of the interior of the first housing 25. As the take-up spring 32, a coiled spring such as a spiral spring is used. An end portion of the take-up spring 32 on the center side is fixed to the core shaft 33, and an outside end portion of the spring 32 is fixed to the first housing 25.

One end 30A of the cable 30 is drawn from a drawing hole 34 formed in the upper surface of the take-up pulley 31. Thereafter, the other end 30B of the cable 30 is rotated clockwise to be wound on a groove 35 formed in the peripheral surface of the take-up pulley 31.

When the cable 30 is dragged, the take-up pulley 31 rotates clockwise to draw the cable 30. On the other hand, the take-up spring 32 shrinks. For this reason, when the cable 30 is set free, the take-up pulley 31 is rotated counterclockwise with restitutive force of the take-up spring 32, the cable 30 is taken up by the take-up pulley 31.

When the cable 30 is dragged, the cable 30 must be held in a drawn state. A holding means for the cable 30 will be briefly described below by using FIG. 3B.

The holding means is generally constituted by a notch 36 formed in the take-up pulley 31 and a lever 37.

The notch 36 is formed in the peripheral portion of the take-up pulley 31. The notch 36 is formed into a V shape having one surface obtained by a cut formed in the radial direction of the take-up pulley 31 and the other surface obtained by a cut formed in the counterclockwise direction with respect to the radial direction.

The lever 37 is integrally constituted by a push rod 38 and a projection 39. The projection 39 is formed on a one-end side 38A of the push rod 38. The projection 39 is formed into a triangular shape to be fitted in the V shape formed by cutting the notch 36. The lever 37 has a structure in which the lever 37 can be rotated about a support P formed at the push rod 38. When the lever 37 is rotated counterclockwise, the projection 39 is fitted in the notch 36 to be engaged with each other.

When the cable 30 is dragged, the lever 37 pivots clockwise on the support P, the notch 36 and the projection 39 are disengaged from each other. As a result, the take-up pulley 31 keeps on rotating clockwise, and the cable 30 is drawn.

On the other hand, when the cable 30 is set free, after the take-up pulley 31 is rotated counterclockwise by the restitutive force of the take-up spring 32, the notch 36 and the projection 39 are engaged with each other. As a result, the rotation of the take-up pulley 31 is stopped, and the cable 30 is held in a drawn state.

In a storing operation of the cable 30, when the other end side 38B of the push rod 38 is pushed about the support P in the clockwise direction, the notch 36 and the projection 39 are disengaged from each other. As a result, the take-up pulley 31 rotates counterclockwise, and the cable 30 is taken up by the take-up pulley 31. The other-end side 38B of the push rod 38 can be moved by pressing a button (not shown) arranged on the side surface of the first housing 25.

A method of using the card-type radio device 24 will be described below.

The first housing 25 and the second housing 26 are integrally engaged with each other to form one card shape. The card-type radio device 24 is inserted into the card slot 8 of the information terminal device 1. In this state, the antenna 29 has poor transmission/reception sensitivity, the second housing 26 is dragged to be separated from the first housing 25. When the second housing 26 is dragged, the cable 30 is drawn from the first housing 25 or the second housing 26 by a predetermined length. As a result, since the second housing 26 can be arranged at an arbitrary position, the antenna 12 can be set at a position where the best transmission/reception sensitivity can be obtained.

The take-up means for storing the cable 30 in the card-type radio device 24 may be arranged in the second housing 26 in place of the first housing 25.

The engagement means for the first housing 25 and the second housing 26 is not limited to the fastener 27A and the fastener 27B.

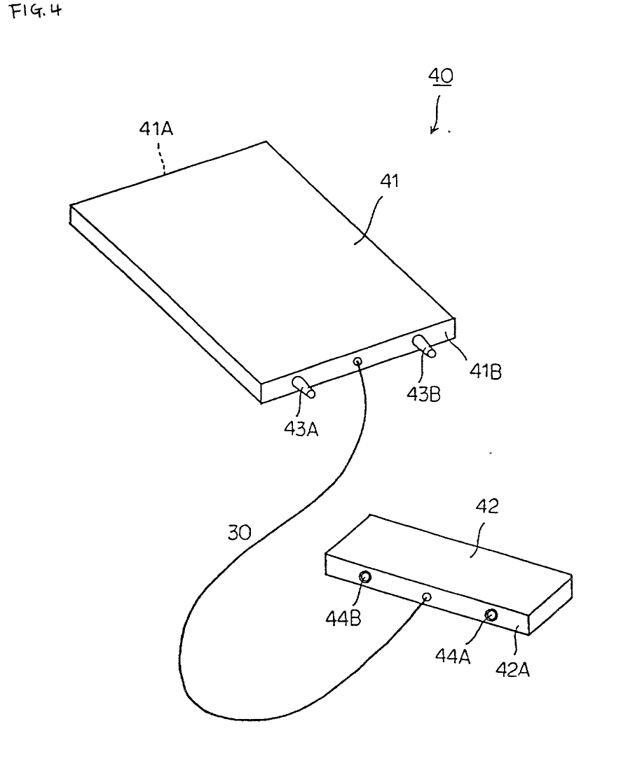

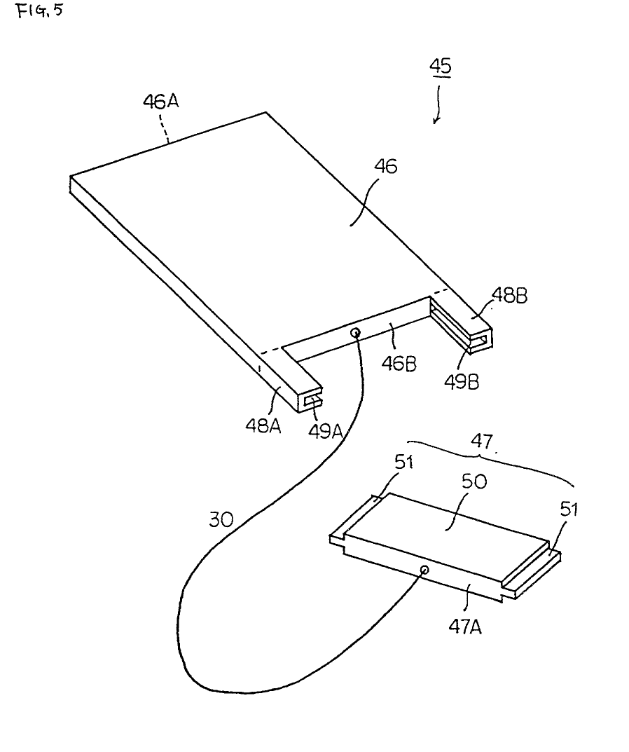

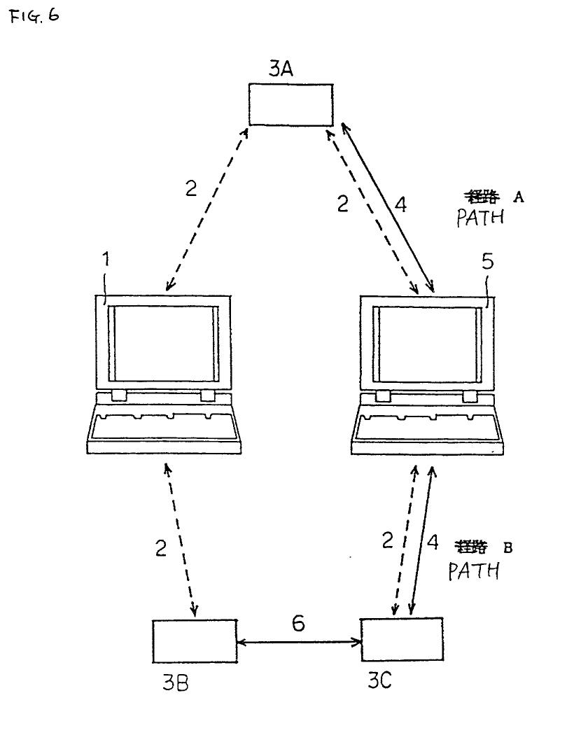

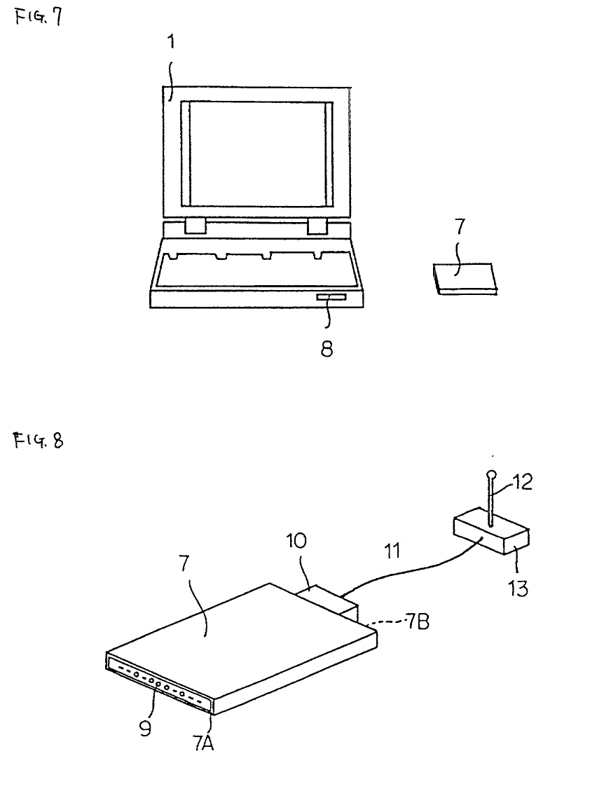

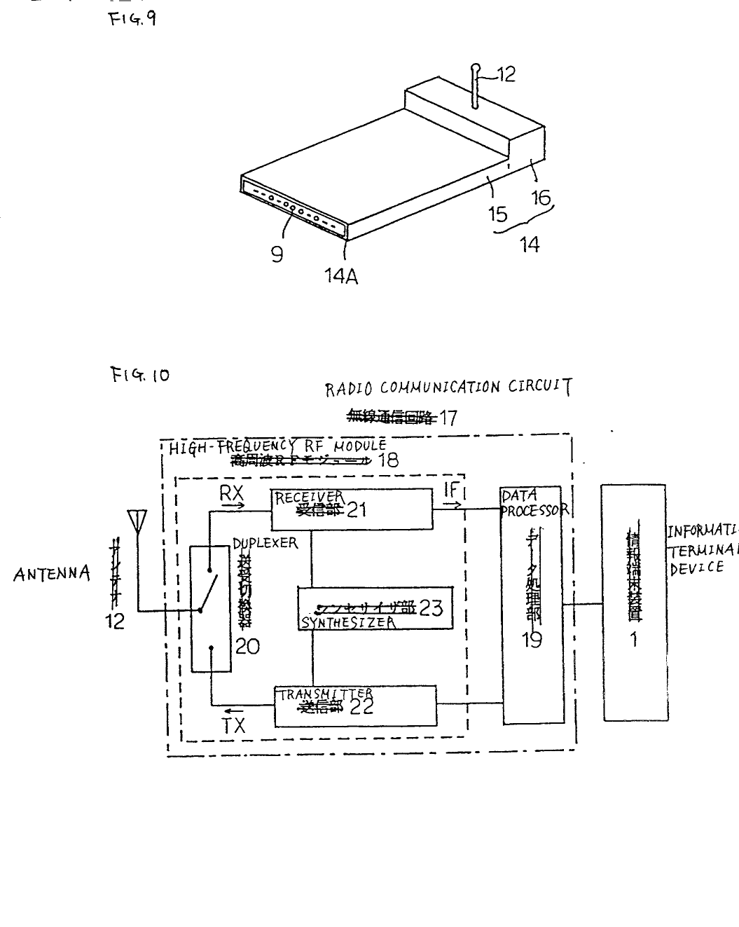

Another engagement means will be described below by using FIG. 4. Since the arrangement except for the engagement means is the same as described above, a description thereof will be omitted.

A card-type radio device 40 is constituted by a first housing 41 and a second housing 42. A radio communication circuit 17 is built in the first housing 41. On a second side surface 41B opposing a first side surface 41A of the first housing 41 on which a connector 9 is arranged, projections 43A and 43B are extended. The projections 43A and 43B are formed to have cylindrical shapes which gradually decrease in diameter from the proximal ends to the distal ends.

In a fitting surface 42A of the second housing 42 overlapping the second side surface 41B, fitting holes 44A and 44B are formed. The fitting holes 44A and 44B are formed to have shapes which gradually decrease in bore from the openings to the internal portions according to the shapes of the projections 43A and 43B.

When the second side surface 41B and the fitting surface 42A overlap, the projection 43A is fitted in the fitting hole 44A, and the projection 43B is fitted in the fitting hole 44B. As a result, the first housing 41 and the second housing 42 are integrally engaged with each other. When the second housing 42 is dragged while holding the first housing 41, the projection 43B is disengaged from the fitting hole 44A, and the projection 43B is disengaged from the fitting hole 44B. As a result, the first housing 41 is separated from the second housing 42.

Another engagement means will be described below by using FIG. 5. Since the arrangement except for the engagement means is the same as described above, a description thereof will be omitted.

A card-type radio device 45 is constituted by a first housing 46 and a second housing 47. A radio communication circuit 17 is built in the first housing 46.

At both the edges of a second side surface 46B opposing a first side surface 46A of the first housing 46 on which a connector 9 is arranged, elongated portions 48A and 48B are formed, respectively. The elongated portions 48A and 48B are formed to have U-shaped sections, and a groove 49A formed in the elongated portion 48A and a groove 49B formed in the elongated portion 48B are oppositely arranged.

The second housing 47 is constituted by a housing 50 and extending plates 51. The extending plates 51 are formed on both the side surfaces perpendicular to a fitting surface 47A of the second housing 47 overlapping the second side surface 46B. The extending plates 51 are formed to extend in a direction perpendicular to the fitting surface 47A.

When the extending plates 51 are inserted into the grooves 49A and 49B, the housing 50 is accommodated between the elongated portions 48A and 48B. Then, the second side surface 46B overlaps the fitting surface 47A. Thus, the first housing 46 and the second housing 47 are integrally engaged with each other. When the second housing 47 is dragged while holding the first housing 46, the extending plate 51 is disengaged from the grooves 49A and 49B. As a result, the first housing 46 is separated from the second housing 47.

According to the card-type radio device of the present invention, when the card-type radio device is inserted into the card slot formed in the information terminal device, if the antenna has poor transmission/reception sensitivity, the second housing can be separated from the first housing to be located at an arbitrary position. Hence, the antenna can be set at a position where the best transmission/reception sensitivity can be obtained, noise can be reduced.

Therefore, communication can be prevented from being inconveniently disconnected in data transmission/reception, or a data error in transmission/reception of character data is eliminated. Reliable communication can be performed between information terminal devices.

What is claimed is:

1. A card-type radio device having a radio communication circuit and an antenna used for transmitting/receiving data, wherein said radio communication circuit is built in a first housing, said antenna is built in a second housing, said radio communication circuit and said antenna are electrically connected to each other through a cable, and said first housing and said second housing are detachably engaged with each other by engagement means.
